(19) United States
(12) Patent Application Publication
(10) Pub. No.: US 2018/0096435 A1
(43) Pub. Date: Apr. 5, 2018

(54) SYSTEM AND METHOD FOR VERIFYING UNSTRUCTURED ENTERPRISE RESOURCE PLANNING DATA

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/724,958

(22) Filed: Oct. 4, 2017

Related U.S. Application Data
(63) Continuation-in-part of application No. 15/361,934, filed on Nov. 28, 2016.
(60) Provisional application No. 62/405,921, filed on Oct. 9, 2016.
(60) Provisional application No. 62/260,553, filed on Nov. 29, 2015.
(60) Provisional application No. 62/261,355, filed on Dec. 1, 2015.

(51) Int. Cl. G06Q 40/00; G06F 17/30

(52) U.S. Cl. CPC G06Q 40/12; G06Q 40/123; G06F 17/30011

(57) ABSTRACT

A system and method for verifying unstructured enterprise resource planning data. The method includes analyzing a first electronic document to determine at least one transaction parameter of a transaction, wherein the first electronic document includes at least partially unstructured data; creating a template for the transaction, wherein the template is a structured dataset including the determined at least one transaction parameter; searching, in an enterprise resource planning system, for a matching second electronic document based on the created template; and verifying the transaction, when the matching second electronic document is found.

### CROSS-REFERENCE TO RELATED APPLICATIONS

This application claims the benefit of U.S. Provisional Application No. 62/405,921 filed on Oct. 9, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to verifying enterprise systems, and more specifically to verifying unstructured data in enterprise resource planning systems.

### BACKGROUND

Enterprise resource planning (ERP) is a business management software typically used to collect, store, manage, and interpret data from various business activities such as, for example, expenses made by employees of an enterprise. ERP systems generally collect data related to business activities of various departments in an enterprise. Such collected data may come from different data sources, and may be in different formats. ERP systems provide an integrated view of this business activity data, and further enable generation of expense reports that can later be sent to the relevant tax authority.

Especially in large enterprises, employees engage in a high number of business activities. Such business activities may further result in a large number of business expenses to be reported to tax authorities. Reporting such business expenses may result in tax breaks and refunds. To this end, employees typically provide receipts based on expenses incurred and are usually required to indicate the types of such expenses. Based on the indication, an ERP system may generate a report which is provided with any received receipts to the relevant tax authority.

Additionally, pursuant to managing the data related to business activities, ERP systems must associate and track relations between sets of the managed data. For example, information related to tax reporting of a receipt must be maintained with an association to the receipt itself. Any errors in associations between data sets can result in incorrect reporting, which in turn may cause loss of profits due to unsuccessful redemptions and exemptions, and failure to comply with laws and regulations. Thus, accurate data management is crucial for ERP systems.

Tracking such data presents additional challenges when portions of the data are unstructured. For example, there are further difficulties associated with tracking expense receipts stored as image files. Some existing solutions to these challenges involve identifying contents of files containing unstructured data based on file extension names provided by users. Such solutions are subject to human error (e.g., typos, mistaking contents of files, etc.), and may not fully describe the contents therein. These disadvantages may further contribute to inaccuracies in ERP systems.

The number of receipts obtained by employees in the course of business may be tremendous. This high number of receipts results in significant increases in data provided to ERP systems, thereby leading to difficulties managing the data in such ERP systems. Specifically, existing solutions face challenges in maintaining correct associations within the managed data. These difficulties may result in errors and mismatches. When the errors and mismatches are not caught in time, the result may be false, related to a plurality of evidences or otherwise incorrect reporting. Manually verifying that reports match receipts is time and labor intensive, and is subject to human error. Further, such manual verification does not, on its own, correct issues with the managed data.

Additionally, existing solutions for automatically verifying transactions face challenges in utilizing electronic documents containing at least partially unstructured data. Specifically, such solutions may be capable of recognizing transaction data in scanned receipts and other unstructured data, but may be inefficient and inaccurate when utilizing the recognized transaction data.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for verifying unstructured enterprise resource planning data. The method comprises: analyzing a first electronic document to determine at least one transaction parameter of a transaction, wherein the first electronic document includes at least partially unstructured data; creating a template for the transaction, wherein the template is a structured dataset including the determined at least one transaction parameter; searching, in an enterprise resource planning system, for a matching second electronic document based on the created template; and verifying the transaction, when the matching second electronic document is found.

Certain embodiments disclosed herein also include a non-transitory computer readable medium having stored thereon causing a processing circuitry to execute a process, the process comprising: analyzing a first electronic document to determine at least one transaction parameter of a transaction, wherein the first electronic document includes at least partially unstructured data; creating a template for the transaction, wherein the template is a structured dataset including the determined at least one transaction parameter; searching, in an enterprise resource planning system, for a matching second electronic document based on the created template; and verifying the transaction, when the matching second electronic document is found.

Certain embodiments disclosed herein also include a system for verifying unstructured enterprise resource planning data. The system comprises: a processing circuitry; and a memory, the memory containing instructions that, when executed by the processing circuitry, configure the system to: analyze a first electronic document to determine at least one transaction parameter of a transaction, wherein the first electronic document includes at least partially unstructured data; create a template for the transaction, wherein the template is a structured dataset including the determined at least one transaction parameter; search, in an enterprise resource planning system, for a matching second electronic document based on the created template; and verify the transaction, when the matching second electronic document is found.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for verifying enterprise resource planning data according to an embodiment.

FIG. 3 is a flowchart illustrating a method for creating a template according to an embodiment.

FIG. 4 is a block diagram of a verifier according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a system and method for verifying enterprise resource planning data by converting at least partially unstructured data into a structured format. A template is created for a first reporting electronic document for verification. The reporting electronic document includes at least partially unstructured data indicating transaction parameters for a transaction. The template is created based on key fields and values identified via analysis of the reporting electronic document. Metadata for the reporting electronic document is generated based on the created template. Using the metadata, the reporting electronic document is verified by searching, in a storage of an enterprise resource planning system, for a matching second evidencing electronic document. If no matching evidencing electronic document is found (i.e., the reporting electronic document is unverified), one or more data sources may be searched to retrieve a matching evidencing electronic document verifying the reporting electronic document.

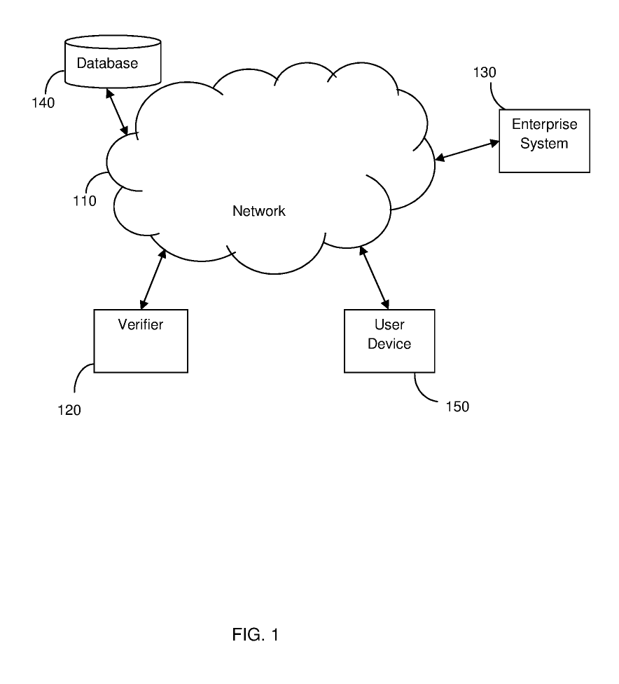

FIG. 1 shows an example network diagram 100 utilized to describe the various disclosed embodiments. The network diagram 100 includes a verifier 120, an enterprise system 130, a database 140, and a user device 150 communicatively connected via a network 110. The network may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to transactions made by the enterprise or representatives of the enterprise as well as enterprise characteristic parameters indicating characteristics of the enterprise such as, but not limited to, country of formation, revenue data, structural data, and the like. The enterprise may be, but is not limited to, a business whose employees may purchase goods and services on behalf of the business. The enterprise system 130 may be, but is not limited to, a server, a database, an enterprise resource planning system, a customer relationship management system, or any other system storing relevant data. In an example implementation, the enterprise system 130 is an enterprise resource planning system storing reporting electronic documents, evidencing electronic documents, or both.

The database 140 stores at least evidencing electronic documents. In an example implementation, the database 140 may be operated by or otherwise associated with the enterprise associated with the enterprise system 130. Thus, the database 140 may store evidencing electronic documents that are not stored in the enterprise system 130 such as, for example, evidencing electronic documents that are not uploaded to the enterprise system 130. When a transaction indicated in a reporting electronic document cannot be verified based on evidencing electronic documents stored in the enterprise system 130, the database 140 may be queried to determine whether the database 140 stores the appropriate evidencing electronic document.

The user device 150 may be, but is not limited to, a personal computer, a laptop, a tablet computer, a smartphone, a wearable computing device, or any other device capable of capturing, storing, and sending unstructured data sets. As a non-limiting example, the user device 150 may be a smart phone including a camera. The user device 150 may be utilized by, for example, an employee of an organization associated with the enterprise system 130.

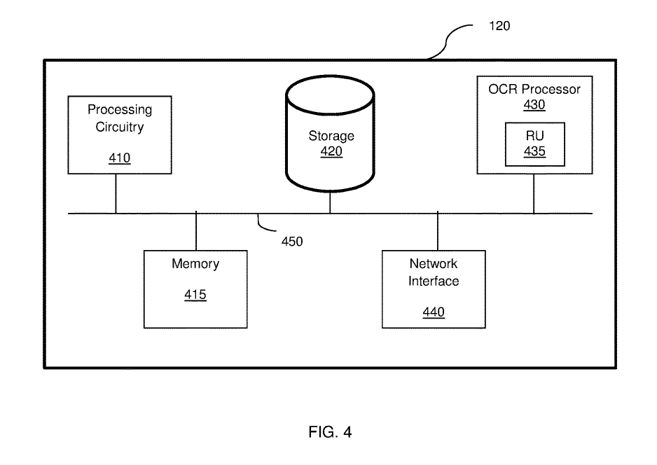

In an embodiment, the verifier 120 includes an optical recognition processor (e.g., the optical recognition processor 430, FIG. 4). The optical recognition processor is configured to identify at least characters in data and, in particular, in unstructured data. The verifier 120 is configured to receive a first reporting electronic document from the enterprise system 130. The reporting electronic document is an at least partially unstructured electronic document including, but is not limited to, unstructured data, semi-structured data, structured data lacking a known format (e.g., a predetermined format recognized by the verifier 120), or a combination thereof.

The reporting electronic document received from the enterprise system 130 is typically, but is not limited to, an electronic document that may be, for example, manually filled in by an employee (by, e.g., typing or otherwise inputting information). In an example implementation, the reporting electronic document may be an image showing an expense report, or an unstructured or semi-structured text file including text of an expense report. The reporting electronic document indicates information related to one or more transactions. As a non-limiting example, the reporting electronic document may include a line filled by an employee stating: “60 Euros in Taxi in Paris@10 Euros per trip” which actually refers to 6 taxi trips of 10 Euros each, i.e., 6 different transactions. In such a case, in order to verify the expense, 6 corresponding evidencing electronic documents are to be matched to the expenses report.

The reporting electronic document may be uploaded to the enterprise system 130 by, e.g., a user of the user device 150. For example, a user of the user device 150 may take a picture of an expense report via a camera (not shown) of the user device 150 and send the image to the enterprise system 130.

In an embodiment, the verifier 120 is configured to analyze the at least partially unstructured reporting electronic document. The analysis may include, but is not limited to, recognizing elements shown in the at least partially unstructured electronic document via computer vision techniques and creating templates of transaction attributes based on the recognized elements. Such computer vision techniques may further include image recognition, pattern recognition, signal processing, character recognition, and the like.

Each created template is a structured dataset including the identified transaction parameters for a transaction. Specifically, the template includes one or more fields representing categories of transaction data, with each field including appropriate transaction parameters. Creation of structured dataset templates is described further herein below.

Based on the created templates, the verifier 120 is configured to generate metadata for each transaction (e.g., a business activity such as an expense) indicated in the at least partially unstructured reporting electronic document. The metadata for a transaction may indicate one or more of the transaction parameters indicated in the reporting electronic document, and may be generated with respect to one or more fields of the respective template.

The fields for which the metadata is generated may be predetermined fields selected to represent information of the transaction that uniquely identifies the transaction such that an evidencing electronic document (e.g., a receipt) that matches the metadata provides evidence of the transaction. As a non-limiting example, for a purchase activity resulting in incurring an expense, the metadata may include a location in which the expense was incurred (indicated in a “location” field), characteristics (e.g., type of business, types of products sold, etc.) of the place of business in which the expense was made (e.g., as indicated in a “business info” field), a time at which the expense was incurred (e.g., as indicated in a “time” field), an amount (e.g., a monetary value or quantity indicated in a corresponding field), combinations thereof, and the like.

The verifier 120 is configured to verify each transaction indicated in the reporting electronic document by searching for a matching evidencing electronic document in the enterprise system 130 based on the generated metadata for the transaction. Specifically, a query may be generated based on the metadata and utilized to search the enterprise system 130 for a matching evidencing electronic document. The matching evidencing electronic document may be associated with metadata matching the metadata generated for the reporting electronic document above a predetermined threshold.

If it is determined that the metadata for the transaction matches the metadata of a respective evidencing electronic document, the report is verified. If it is determined that there is a mismatch (i.e., the identified report structured data does not match the metadata of any evidencing electronic document stored in the enterprise system), a notification regarding the mismatch may be generated and sent to, e.g., the user device 150. Alternatively or collectively, when a mismatch is identified such that the one or more of the transactions is unverified, the verifier 120 may be configured to search for a matching evidencing electronic document for every unverified transaction in the database 140. If a match is found in the database, the verifier 120 may be configured to store the matching evidencing electronic document in the enterprise system 130 and to determined that the respective transaction is verified.

Using structured templates for verifying enterprise data allows for more efficient and accurate determination than, for example, by utilizing unstructured data directly. Specifically, metadata generated based on the templates may be generated with respect to particular fields such that the metadata more efficiently and more accurately demonstrates parameters that uniquely identify the transaction. Accordingly, the metadata may be used to accurately search for matching evidencing electronic documents while reducing processing power and time related to comparing metadata. Additionally, the template may be stored instead of the reporting electronic document in the enterprise system 130 and, thus, may reduce memory usage as compared to storing the electronic document itself, especially when the electronic document is an image or other digital representation of visual data, as such visual representations typically require more memory usage than a structured text-based document.

The verifier 120 typically includes a processing circuitry (e.g., the processing circuitry 410, FIG. 4) coupled to a memory (e.g., the memory 415, FIG. 4). The processing circuitry may comprise or be a component of a processor (not shown) or an array of processors coupled to the memory. The memory contains instructions that can be executed by the processing circuitry. The instructions, when executed by the processing circuitry, configure the processing circuitry to perform the various functions described herein.

It should be understood that the embodiments disclosed herein are not limited to the specific architecture illustrated in FIG. 1, and that other architectures may be equally used without departing from the scope of the disclosed embodiments. Specifically, the verifier 120 may reside in a cloud computing platform, a datacenter, and the like. Moreover, in some implementations, there may be a plurality of verifiers operating as described hereinabove and configured to either have one as a standby, to share the load between them, or to split the functions between them.

It should also be noted that some of the embodiments discussed with respect to FIG. 1 are described as interacting with only one enterprise system 130 merely for simplicity purposes and without limitations on the disclosure. Data from additional enterprise resource planning systems may be verified by the verifier 120 without departing from the scope of the disclosed embodiments. Additionally, the database 140 may equally be another data source such as, for example a server having access to one or more databases. Further, multiple databases may be utilized without departing from the scope of the disclosure.

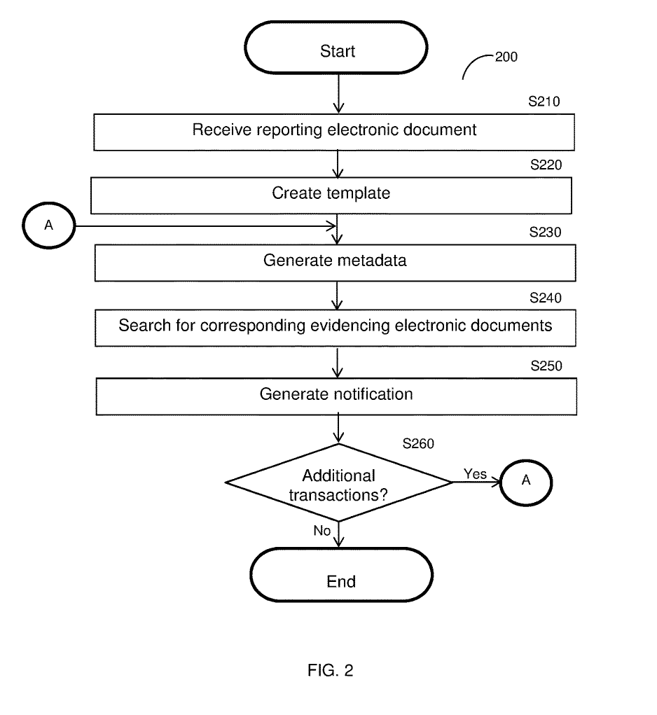

FIG. 2 is an example flowchart 200 illustrating a method for verifying data in an enterprise system according to an embodiment. In an embodiment, the method may be performed by a verifier (e.g., the verifier 120).

At S210, a first reporting electronic document is received or retrieved. The reporting electronic document includes at least partially unstructured data related to one or more transactions. The at least partially unstructured data includes, but is not limited to, unstructured data, semi-structured data, or structured data lacking a known format. The transaction electronic document may be retrieved from, for example, an enterprise resource planning (ERP) system (e.g., the enterprise system 130, FIG. 1), or may be received from, for example, a user device (e.g., the user device 150, FIG. 1).

In an example implementation, the transaction electronic document may be an image showing, for example, one or more expense reports related to business activities. As a non-limiting example, the image may be captured by a mobile device operated by an employee of an organization who takes a picture of an expense report form.

At S220, a template is created for each transaction indicated in the reporting electronic document. In an embodiment, the transaction electronic document may be analyzed via an optical character recognition (OCR) processor. The analysis may further include using machine vision to identify elements in the at least partially unstructured data, cleaning or disambiguating the data, and generating a structured data including key fields and values identified in the at least partially unstructured data. As an example, for an image of a receipt, machine vision may be utilized to identify information related to a transaction noted in the receipt such as price, location, date, buyer, seller, and the like.

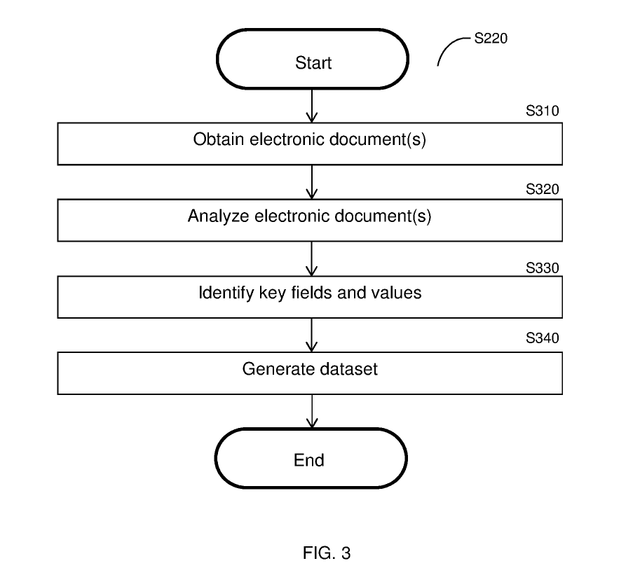

In some implementations, the disambiguation may include identifying multiple transactions within one set of fields and key values in the template. The identification of multiple transactions may be based on one or more multi-transaction identification rules. For example, such rules may be based on a total price, e.g., if the total price is above a threshold value, it may be determined that the total price represents multiple transactions. A template may be created for each of the multiple transactions. Disambiguation during template creation is described further herein below with respect to FIG. 3.

At S230, based on one of the created templates, metadata is generated for the respective transaction. The metadata may be generated based on values in fields that uniquely identify the transaction. As a non-limiting example, for a template including the fields “date,” “price,” “quantity,” and “item name” or “item number,” metadata indicating the values in those fields may be generated.

At S240, a corresponding evidencing electronic document is searched for in order to verify the transaction. In an embodiment, S240 may include generating a query based on the metadata, and searching for a matching evidencing electronic document through one or more data sources using the generated query. In an example implementation, the data sources include an enterprise resource planning system.

In an embodiment, if no matching evidencing electronic document is found in a first data source, a second set data source may be searched for matching evidencing electronic documents. If a matching evidencing electronic document is found in the second data source, it may be retrieved and stored in the first data source.

At optional S250, a notification may be generated. The notification may indicate whether the transaction was verified, i.e., whether a matching evidencing electronic document could be found for the transaction.

In S260, it is checked whether additional transactions are to be verified and, if so, execution continues with S230; otherwise, execution terminates.

FIG. 3 is an example flowchart S220 illustrating a method for creating a template based on an electronic document including at least partially unstructured data according to an embodiment.

At S310, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S320, the electronic document is analyzed to identify elements in the at least partially unstructured data. The analysis may include, but is not limited to, using optical character recognition (OCR) to determine characters in the electronic document.

The elements may include, but are not limited to, characters, strings, or both, related to a transaction. As a non-limiting example, the elements may include printed data appearing in an expense receipt related to a business activity. Such printed data may include, but is not limited to, date, time, quantity, name of seller, type of seller business, value added tax payment, type of product purchased, payment method registration numbers, and the like.

At S330, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

In another embodiment, S330 may further include disambiguating the unstructured data. The disambiguation may be based on, but not limited to, a file name of the unstructured data set, dictionaries, algorithms, thesauruses, and the like. Disambiguation may result in more accurate identification of the transactions. The disambiguation may be based on, but not limited to, the structure of the data (e.g., data in a field “Destination” may be disambiguated based on names of locations), dictionaries, algorithms, thesauruses, and the like. In some implementations, if disambiguation is unsuccessful, a notification may be generated and sent to a user (e.g., a user of the user device 150), prompting the user to provide further clarification.

As a non-limiting example, for an image in a file titled “Purchase Receipt,” a string “$300.00” character on the same line as the string “Total Price” may be utilized to determine that the value to be included in a “purchase price” field is $300.00. As another example, the string “Drance” may be disambiguated based on a dictionary to result in metadata indicating that a location associated with the unstructured data set is France. As yet another example, in a field related to the type of expense, the structured data for a field may be “Taxi in Paris” and value for the field may be “60 Euros”. Based on one or more rules for maximum taxi price, it may be determined that the amount “60 Euros” is too high for a taxi expense and, therefore, that the field corresponds to multiple taxi trips.

At S340, a structured dataset is generated. The generated dataset includes the identified key fields and values.

It should be noted that the embodiments described herein above with respect to data in ERP systems is described as structured data merely for simplicity purposes and without limitations on the disclosed embodiments. Semi-structured data may be used equally without departing from the scope of the disclosure. Additionally, the data may be stored in any databases or other storage units communicatively connected to systems other than ERP systems. It should further be noted that the embodiments described herein above with respect to FIGS. 2 and 3 are discussed with respect to FIG. 1 merely for example purposes and without limitation on the disclosed embodiments.

FIG. 4 is an example schematic diagram of the verifier 120 according to an embodiment. The verifier 120 includes a processing circuitry 410 coupled to a memory 415, a storage 420, and a network interface 440. In an embodiment, the verifier 120 may include an optical character recognition (OCR) processor 430. In another embodiment, the components of the verifier 120 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 415 may be volatile (e.g., RAM, etc.), non-volatile (e.g., ROM, flash memory, etc.), or a combination thereof. In one configuration, computer readable instructions to implement one or more embodiments disclosed herein may be stored in the storage 420.

In another embodiment, the memory 415 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 410 to perform the various processes described herein. Specifically, the instructions, when executed, cause the processing circuitry 410 to generate consolidated data based on electronic documents, as discussed herein.

The storage 420 may be magnetic storage, optical storage, and the like, and may be realized, for example, as flash memory or other memory technology, CD-ROM, Digital Versatile Disks (DVDs), or any other medium which can be used to store the desired information.

The storage 420 may also store metadata generated based on analyses of unstructured data by the OCR processor 430. In a further embodiment, the storage 420 may further store queries generated based on the metadata.

The OCR processor 430 may include, but is not limited to, a feature and/or pattern recognition processor (RP) 435 configured to identify patterns, features, or both, in unstructured data sets. Specifically, in an embodiment, the OCR processor 430 is configured to identify at least characters in the unstructured data. The identified characters may be utilized to create a dataset including data required for verification of a request.

The network interface 440 allows the verifier 120 to communicate with the enterprise system 130, the database 140, the user device 150, or a combination of, for the purpose of, for example, receiving electronic documents, sending notifications, searching for electronic documents, storing data, and the like.

It should be understood that the embodiments described herein are not limited to the specific architecture illustrated in FIG. 4, and other architectures may be equally used without departing from the scope of the disclosed embodiments.

It should be noted that various embodiments described herein are discussed with respect to verifying a single transaction indicated in a reporting electronic document merely for simplicity purposes and without limitation on the disclosed embodiments. Multiple transactions indicated in a reporting electronic document may be verified, in series or in parallel, without departing from the scope of the disclosure. As a non-limiting example, the reporting electronic document may be an expense report indicating multiple transactions made by an employee.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for verifying unstructured enterprise resource planning data, comprising:
analyzing a first electronic document to determine at least one transaction parameter of a transaction, wherein the first electronic document includes at least partially unstructured data;
creating a template for the transaction, wherein the template is a structured dataset including the determined at least one transaction parameter;
searching, in an enterprise resource planning system, for a matching second electronic document based on the created template; and
verifying the transaction, when the matching second electronic document is found.

2. The method of claim 1, wherein determining the at least one transaction parameter further comprises:
identifying, in the first electronic document, at least one key field and at least one value;
creating, based on the first electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the first electronic document to determine data in the first electronic document; and
extracting, based on a predetermined list of key fields, at least a portion of the determined data, wherein the at least a portion of the determined data matches at least one key field of the predetermined list of key fields.

4. The method of claim 3, wherein analyzing the first electronic document further comprises:
performing optical character recognition on the first electronic document.

5. The method of claim 1, further comprising:
generating, based on the created template, a query, wherein the searching includes querying the enterprise resource planning system using the generated query.

6. The method of claim 1, further comprising:
generating, based on the template, metadata for the transaction, wherein the query is generated based on the metadata, wherein the second electronic document is associated with metadata, wherein the metadata of the matching second electronic document matches the generated metadata above a predetermined threshold.

7. The method of claim 1, wherein creating the template further comprises:
disambiguating the at least partially unstructured data.

8. The method of claim 1, further comprising:
searching, in a database, for the matching second electronic document, when the matching second electronic document is not found in the enterprise resource planning system; and
storing the second electronic document in the enterprise resource planning system, when the matching second electronic document is found in the database.

9. A non-transitory computer readable medium having stored thereon instructions for causing one or more processing units to execute a process for verifying unstructured enterprise resource planning data, the process comprising:
analyzing a first electronic document to determine at least one transaction parameter of a transaction, wherein the first electronic document includes at least partially unstructured data;
creating a template for the transaction, wherein the template is a structured dataset including the determined at least one transaction parameter;
searching, in an enterprise resource planning system, for a matching second electronic document based on the created template; and
verifying the transaction, when the matching second electronic document is found.

10. A system for verifying unstructured enterprise resource planning data, comprising:
a processing circuitry; and
a memory, the memory containing instructions that, when executed by the processing circuitry, configure the system to:
analyze a first electronic document to determine at least one transaction parameter of a transaction, wherein the first electronic document includes at least partially unstructured data;
create a template for the transaction, wherein the template is a structured dataset including the determined at least one transaction parameter;
search, in an enterprise resource planning system, for a matching second electronic document based on the created template; and
verify the transaction, when the matching second electronic document is found.

11. The system of claim 10, wherein the system is further configured to:
identify, in the first electronic document, at least one key field and at least one value;
create, based on the first electronic document, a dataset, wherein the created dataset includes the at least one key field and the at least one value; and
analyze the created dataset, wherein the at least one transaction parameter is determined based on the analysis.

12. The system of claim 11, wherein the system is further configured to:
analyze the first electronic document to determine data in the first electronic document; and
extract, based on a predetermined list of key fields, at least a portion of the determined data, wherein the at least a portion of the determined data matches at least one key field of the predetermined list of key fields.

13. The method of claim 12, wherein the system is further configured to:
perform optical character recognition on the first electronic document.

14. The method of claim 10, wherein the system is further configured to:
generate, based on the created template, a query, wherein the searching includes querying the enterprise resource planning system using the generated query.

15. The method of claim 10, wherein the system is further configured to:
generate, based on the template, metadata for the transaction, wherein the query is generated based on the metadata, wherein the second electronic document is associated with metadata, wherein the metadata of the matching second electronic document matches the generated metadata above a predetermined threshold.

16. The method of claim 10, wherein creating the template further comprises:
disambiguate the at least partially unstructured data.

17. The method of claim 10, wherein the system is further configured to:
search, in a database, for the matching second electronic document, when the matching second electronic document is not found in the enterprise resource planning system; and
store the second electronic document in the enterprise resource planning system, when the matching second electronic document is found in the database.
